(19) United States
(12) Patent Application Publication
(10) Pub. No.: US 2018/0097816 A1
(43) Pub. Date: Apr. 5, 2018

(54) ACCESS CONTROL MECHANISMS BASED ON COMPUTATIONAL BEHAVIOR

(71) Applicant: Sensoriant, Inc, Cedar Knolls, NJ (US)

(72) Inventors: Shamim A. Naqvi, Morristown, NJ (US); Robert Frank Raucci, New York, NY (US)

(21) Appl. No.: 15/833,927

(22) Filed: Dec. 6, 2017

Related U.S. Application Data
(63) Continuation-in-part of application No. 15/352,861, filed on Nov. 16, 2016.
(60) Provisional application No. 62/430,543, filed on Dec. 6, 2016.
(60) Provisional application No. 62/321,302, filed on Apr. 12, 2016.
(60) Provisional application No. 62/355,290, filed on Jun. 27, 2016.

(51) Int. Cl. H04L 29/06

(52) U.S. Cl. CPC H04L 63/102; G06F 21/6218; H04L 63/107

(57) ABSTRACT

A method of authorizing a user to access a resource over a communication network includes receiving over a communication network from a computing device associated with the user a temporal sequence of operational data of parameter values for one or more parameters monitored by the computing device. The temporal sequence of operational data is compared to a temporal sequence of previously received training data of parameter values previously monitored by the communication device for the one or more parameters. The computing device is allowed access to the resource if the temporal sequence of previously received training data matches the temporal sequence of operational data to within a specified confidence level.

### CROSS-REFERENCE TO RELATED APPLICATIONS

This application claims the benefit of U.S. Provisional Application No. 62/430,543, filed Dec. 6, 2016. This application is also a continuation-in-part of U.S. application Ser. No. 15/352,861, filed Nov. 16, 2016, which claims the benefit of U.S. Provisional Application Nos. 62/321,302, filed Apr. 12, 2016 and 62/355,290, filed Jun. 27, 2017, the contents of which are incorporated herein by reference.

### BACKGROUND

The use of personal identity is ubiquitous in personal, business and online services. It is common now for people to carry, own or wear multiple smart devices and user adoption is growing. Current online user identity mechanisms are based on user's remembering or saving information related to their identities. User's often forget the multiple pieces of information they need to remember. Malicious entities steal or guess credentials saved by users and thus gain access to stored data and other resources. Thus, database systems become vulnerable to data breaches. A mechanism that is independent of stored information and memorization by users would improve database technology.

### SUMMARY

In one aspect, a method of authorizing a user to access a resource over a communication network is provided. In accordance with the method a temporal sequence of operational data of parameter values for one or more parameters monitored by a computing device associated with the user are received over a communication network from the computing device. The temporal sequence of operational data is compared to a temporal sequence of previously received training data of parameter values previously monitored by the communication device for the one or more parameters. The computing device is allowed access to the resource if the temporal sequence of previously received training data matches the temporal sequence of operational data to within a specified confidence level.

In another aspect, a method of gaining access to a resource over a communication network is provided. The method includes: (i) obtaining, with a computing device associated with a user, a temporal sequence of training parameter values for one or more parameters being monitored by the computing device; (ii) sending the training parameter values over a communication network from the computing device to an access control mechanism associated with the resource; (iii) subsequent to (i), obtaining, with the computing device, a temporal sequence of operating parameter values for the one or more parameters being monitored by the computing device; (iv) sending the operating parameter values over the communication network from the computing device to the access control mechanism; and (vi) receiving from the access control mechanism over the communication network access to the resource if the temporal sequence of training parameters values matches the temporal sequence of operational parameter values to within a specified confidence level.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTIONS OF DRAWINGS

FIG. 1A illustrates one example of a process that may be employed to allow user access to a database or other resource.

FIG. 1B illustrates one example of an Environment Sensory Dataset that may be obtained by monitoring service logic in a user computing device.

FIG. 2 illustrates an exemplary finite state machine or profile.

FIG. 3A illustrates an exemplary relational database table.

FIG. 3B is a flowchart illustrating one example of a method for deriving device profiles or finite state machine representations of environmental sensory datasets.

FIG. 4 is a flowchart illustrating one example of a method by which a user replaces a lost computing device that incorporated monitoring service logic and associated data for gain access to one or more resources.

FIG. 5: illustrates on example of a task list of tasks that a user of a lost computing device may be asked to perform on a replacement computing device.

FIG. 6 illustrates multiple user computing devices that may be associated with a single user.

FIG. 7 shows an example architecture for a device such as the user computing device or the access control mechanism that executes the supervisory program that provides a user access to a database or other online resource.

### DETAILED DESCRIPTION

### Motivation

Database systems and computer systems often utilize user authentication technologies to control access to the system. Authentication mechanisms comprise the fundamental components of database systems since unauthorized access may lead to loss of data, privacy of users, user data, corporate data, etc. Such losses of data are often referred to in literature as data breaches. Authentication technologies and mechanisms contribute in large measure to consumer and commercial trust in database technology.

Authentication mechanisms are also used by consumers to gain access to many computer systems and websites. Once granted access a consumer may then be authorized to access different kinds of data and resources. A malicious entity gaining access to a computer system or a website may thus cause damage by corrupting data, sending false messages, planting code that allows future unauthorized accesses (i.e., Trojan horses), etc. Unauthorized access may ultimately be parlayed by malicious entities into large number of users to lose their personal and business data.

The most common authentication mechanism used to safe guard database technology is the method that uses username/password combinations selected by users. This mechanism is prone to attacks, e.g., malicious entities may try various combinations of letters and strings to guess or compute the username/password combination of a user. As computers become more efficient and powerful, increasingly larger number of combinations can be tried to guess the username/password and gain access for malicious activities.

The present invention presents methods for improving access control mechanisms of database technology by minimizing the probability by which username/password combinations may be guessed or computed by malicious entities. A hallmark of the present invention is that it may be used to control access to database systems and other computing resources when enormously powerful computers, e.g., von Neumann machines fabricated using 10 Nm class of technology or even quantum computers, that may calculate quadrillions of combinations in an exceedingly small amount of time, e.g., by exploiting (quantum) parallelism, become commercially available. Such computers may be capable of breaking access control mechanisms that are based on combinations of characters. In some embodiments, a database system may employ both the mechanism of the present invention and a conventional username/password (or other) mechanism.

The term authentication refers to establishment of a user's identity. For example, in online environments, touch surfaces are being introduced to read the fingerprints of users to establish authentication. Retina scans have been discussed in prior art. Facial images are being interpreted to recognize consumers and allow or disallow access.

The term authorization usually defines services that people can access or that may be made available to them. For example, in some countries, purchase of certain items is dependent on the customer's proof of age. In the US, it is possible to purchase tobacco products or gain admittance to nightclubs based on proof of age. Thus, once a consumer has been authenticated, he may be allowed access to tobacco or other resources.

Whilst there are many kinds of authentication mechanisms, we discuss three primary methods as they are emblematic of the class.

As mentioned earlier, the most common method of authentication is to require a user to remember a user name (also called a “userid” in prior art) and password combination. The problems with this mechanism are well known in prior art. Users often access many websites and computer systems. Many service providers have different rules and policies governing usernames/password combinations. For example, some providers require at least one capital letter to be chosen in a username, another may require capital letters and numbers, or special characters such as “%”, “$”, etc. A provider may ask a user to change his username/password combination every month. Another provider may require that when changing a username/password, a user must not use a previously chosen combination.

As a consequence of such varied rules across multiple service providers, a user today may end up with many username/password combinations that he may need to remember or memorize.

Faced with the burden of remembering or memorizing larger and larger number of username/password combinations, users resort to storing username/password combinations. However, the storage techniques used may themselves be unsafe and hence vulnerabilities may be introduced into the authentication mechanism based on username/password combinations.

For example, it has been reported in prior art that users may write down username/password combinations into a notebook, which may be stolen or lost. Users communicate their username/passwords in unsafe communications, e.g., unencrypted emails. Phishing attacks may trap users into revealing their username/password data.

A more recent innovation in online credentials is the method of private and public key mechanisms (also sometimes referred to as private and public addresses). In these schemes, users generate a pair of keys. A key is a bit string whose length is commonly expressed in bits, e.g., 256 bits. In some instances, hexadecimal digits in base-16 arithmetic are used to specify the length of a string where a hexadecimal is represented by 4 bits. The hexadecimal digits are [0-9, A-F]. A private or public key is a sequence of binary digits with a pre-determined length, e.g., 64-hexadecimal digits. The keys are generated by well-known processes.

A crucial property of the private/public mechanisms is that users are required to safeguard the private key since any user with a private key is assumed to be authenticated. Thus, if a user loses his private key, he has no recourse to recovering his data. Any consumer finding a lost private key will gain unfettered access to the corresponding data of the owner. Since it is arduous to remember a sequence of 256-bits, many users save their private keys in a file (or write them down). The latter practice is dangerous and unsafe as mentioned earlier. For example, access to Bitcoin finances is controlled by private keys and several cases have been reported wherein users have lost access to their Bitcoin funds due to loss of private keys.

A third authentication mechanism is that of fingerprint recognition using touch surfaces such as provided by modern mobile phone displays. The main problem with this technology is the public's concern with invasion of privacy and sharing of fingerprints by the controlling service provider with unauthorized entities and agencies. Therefore, users prefer that their fingerprint data be kept on their local device and not be uploaded to servers. If a user loses his personal device, he is then required to acquire a new device, re-establish his credentials with the service provider using one of the two methods described above (username/password combination or private key) and then re-establish his fingerprint identity on the local device. Thusly, fingerprint authentication reduces to username/password authentication in the case of loss of device. And since modern users have multiple and an increasing number of smart devices, the concomitant problems of username/password based mechanisms are expected to multiply.

### General Approach

The term “user computing device” as used herein denotes devices with one or more processors, wireless and/or wireline communication capabilities and interfaces, and input/output interfaces (e.g., touch surfaces). Typically, one or more sensor devices may be contained in or associated with a user computing device, e.g., temperature, location, motion and imaging sensors, etc. Examples of such devices without limitation are smart phones, personal digital assistants, tablet computers, desktop computers, laptops, smart glasses, smart watch, etc. We assume that users referred to herein have one or more user computing devices.

User computing devices may be responsive to user issued commands. A user may also cause user computing devices to be under programmatic control and exhibit “stand-alone” behavior, i.e., the user may issue a programmatic policy that controls one or more actions undertaken by the device over a period.

Certain classes of user computing devices may also exhibit semi-autonomous behavior in the sense that they may respond to external stimuli, e.g., received via one or more sensor devices associated with the device, without apparent intervention by the user.

In some embodiments, a user computing device may inject one or more computer programs into a database or computer system wherein the injected program(s) may run over a period and exhibit apparent autonomous behavior.

In one aspect, a method of the present invention is based in part on sensory data obtained from a user's smart devices, sensors associated with the user's smart devices, other smart devices near the user, networks (wired and/or wireless) in communication with the user's device, application programs used by the user, and so on.

Data from physical or software-based sensors within or proximate to smart devices may be received, processed and collected by user devices or sent to servers in network connection with the smart devices.

For example, the work location of a user may support a Wi-Fi network. Thus, when the user is at his work location, his smart device may connect with the Wi-Fi network, receive data from the Wi-Fi router, record said data or send it to a server connected to said smart device.

Furthermore, when a user is at home, his smart phone may connect to his home Wi-Fi network that may generate a different data set. When the user is in his car, his smart device may establish a Bluetooth connection with the music system of his car, thus generating other recordable data.

It is thus seen that as the user goes about his daily routine, his device(s) receive data from one or more other devices, sensors and networks. We may thus acquire data about such devices, the time and duration of connections, patterns of connecting to one network/device followed by connecting to another network or device, etc. Thus, the presence of the user on various networks, his transitions from one network to another, the duration and timing of such network connections, his presence at various geographic locations and the associated dates, times and days may all be recorded as datasets by a user's device(s) or by servers connected to said devices. Such datasets may be referred to as environmental sensory datasets and may be analyzed resulting in deriving a pattern from events. For example, we may be able to describe one such pattern as “User spent X amount of time connected to a network “A”, Y amount of time connected to an automobile Bluetooth network “B”, and Z amount of time connected to network “C””. As another example, we may derive a rule that describes the average time a user takes to transition from network “A” to network “B” in more than 80% of all network transitions.

The present invention envisions a monitoring program embedded in a user computing device collecting environmental sensory datasets that are then, in turn, used to obtain and store one or more device profiles over a pre-determined time, say 1 week. Next, we may collect an environmental sensory dataset, say daily, and obtain a daily device profile from it. An authentication mechanism may then “match” the weekly device profiles with a “daily” device profile and allow or disallow a user from accessing one or more resources.

It is to be noted that the device profile as described represents an encapsulation of the user's computational behavior over a period. Authentication mechanisms based on such user behaviors thus do not rely on username/password combinations and are not susceptible to malicious attacks based on “computing or guessing” username/password combinations. It should be further noted that although the methods described herein based user behavior patterns generally may be assumed to be sufficient to authenticate the user, in some cases it will only be necessary to use these behavior patterns to authorize a user to gain access to a resource, without also assuming that the user has in fact been authenticated. Moreover, in some case the amount of user behavior that needs to be examined and the degree to which it is required to match training data (discussed below) may differ depending on whether, for instance, only authorization is to be provided or both authentication and authorization are to be provided. For example, authentication and authorization may require more stringent criteria than authorization alone.

Profiles based on computational behavior of a user may be circumvented by “mimicking” a user's computational behavior over a given period of time. We believe such mimicking activity to be mostly impractical. For example, it may entail a malicious agent to gain physical access for several hours to a user's office, his home or access his Wi-Fi networks, access to a user's smart car, etc.

There is a possibility that a user may lose his user computing device and allow malicious entities to access his environmental sensory dataset. We address this issue and its solution later.

### Building Environmental Sensory Datasets

In some embodiments, a database system uses the methods described herein as an authentication mechanism for controlling user access by constructing a supervisory program running in the database system. The supervisory program uses the methods described herein to allow or disallow access to the database system.

Users wishing to access the database system are required to possess one or more user computing devices that are provisioned by the supervisory program with a monitoring service logic, i.e., a computer program, to collect environmental and sensory data into a dataset. A user may utilize the fingerprint mechanism of his device to authenticate himself to his device that may then acquire, e.g., download, the monitoring service logic.

The supervisory program may now trigger the monitoring service logic to begin a so-called “training phase” during which the logic collects environmental sensory data from the user computing device. Having collected the dataset, the monitoring service logic communicates it to the supervisory program that, in turn, obtains one or more profiles of the user device for the received dataset. These profiles, called “training profiles”, will be used by the supervisory program as an authentication mechanism.

Having derived the training profiles, the supervisory program triggers the monitoring service logic to enter an “operational phase” in which an “operational” environmental sensory dataset is collected by the logic.

When the user wishes to access the database system, the supervisory program requests the monitoring service logic to provide it the “operational” dataset from which the supervisory program obtains one or more operational profiles. The latter are “matched” (as described later) with the training profiles. If the match is deemed successful, the user is granted access to the database system by the supervisory program; otherwise the user may be disallowed access.

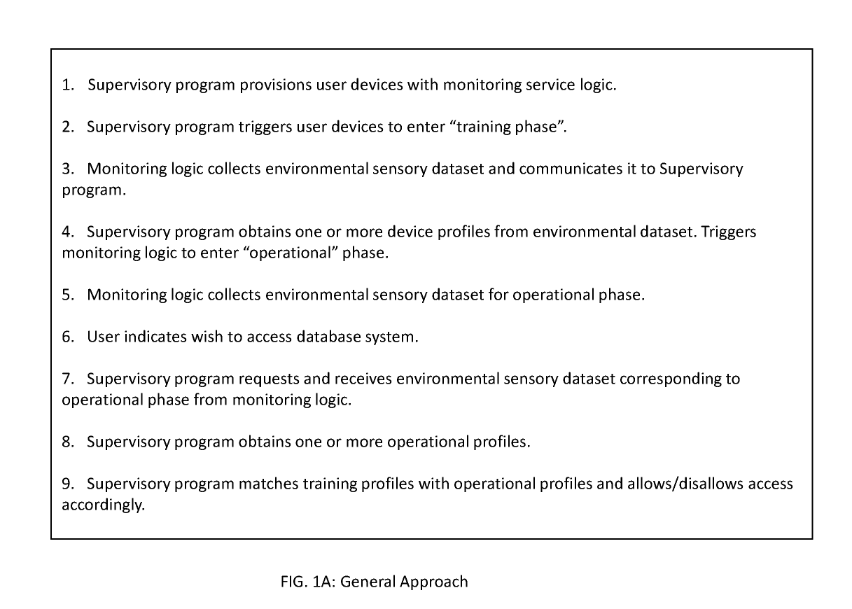

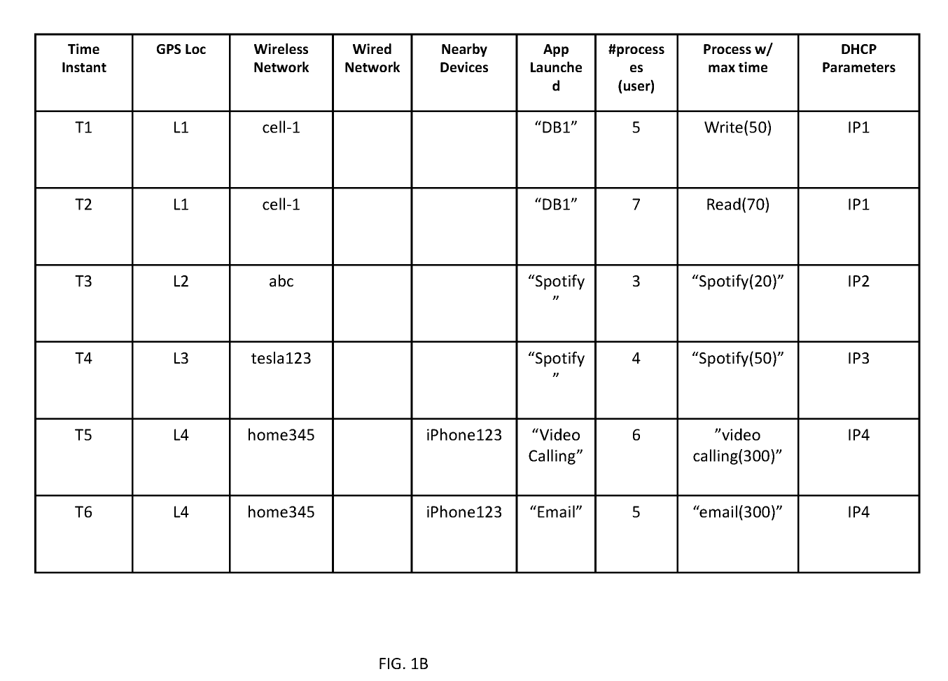

FIG. 1A summarizes the above general approach of the inventions described herein.

A function of the monitoring service logic during the training phase is to record various parameter values concerning the user's environment and actions at a periodic rate. These values may be recorded in a dataset and communicated to the supervisory program. In some embodiments, the supervisory program or the monitoring logic may represent the dataset in multiple ways.

One way to organize the environmental sensory dataset is as a tabular data structure (see, e.g., FIG. 1B). The recording function of the monitoring logic records values of the computational environment of the user device and the values so obtained are arranged in rows (data records) of the tabular data structure.

FIG. 1B shows exemplary data records that may be obtained by the monitoring service logic during the training phase. Note that operations that construct such tabular structures are known in prior art and may be programmed by people with ordinary skill. In some embodiments, the periodicity of the recording operation of the monitoring service logic may be adjusted or altered randomly or by system policy.

The rows of FIG. 1B represent “snapshots in time” of the user's computational environment. The first row of the table may be interpreted as follows.

At time T1, the user is connected to the cellular network “cell-1” having launched application “DB1”. The user computing device has 5 “user” processes (as opposed to “system” processes). (Note that the latter information is typically available to computer programs by making a system call to the operating system of the user computing device.) The “write” process has taken the maximum amount of time from all user processes, the maximum value being 50 units of time. The DHCP (Dynamic Host Configuration Protocol) parameters column shows the IP address being “IP1”. (Other DHCP parameters are not shown.)

The second row (Time Instant T2) may be interpreted as being similar to row 1, the differences being that at time instant T2 the number of user processes is 7 and the process that has taken the most time is “read” with value 70 units.

The third row (Time Instant T3) of the table shows the user device being connected to a Wi-Fi network named “abc” that has another device “iPhone123” connected to it also. In FIG. 1B we denote devices that are connected to the same Wi-Fi network as “nearby” devices. Generally, Nearby Devices may additionally include devices that detect, discover or connect to proximate devices using various authorization and/or authentication schemes. For example, devices using the Bluetooth discovery protocol may require pin codes or passwords for “pairing”. NFC (Near Field Communication) protocols may require biometric verification of one or more users when establishing communications between user devices. Many discovery and proximity protocols are known in prior art.

Turning back to FIG. 1B, row 3 also shows that the user device is now running application “Spotify” with 3 user processes and that the process “Spotify” has taken 20 units of time.

Note that whereas at time instants T1 and T2 the user computing device was running the application “DB1”, at time instant T3 it is running a different application, i.e., “Spotify”. That is, the data records collected by the monitoring service logic are not made available to the supervisory program in real time. Rather they may be collected by the monitoring service logic and provided later to the supervisory program for processing purposes.

The remaining rows of FIG. 1B may be interpreted similarly.

Generally, we will refer to the rows of the table of FIG. 1B as representing the states of the user's environment as discerned by his computing device(s). (Whereas FIG. 1B shows data from a single device, we will shortly introduce the notion of users with multiple computing devices.)

Turning now to the columns of FIG. 1B, we observe that columns may be interpreted as parameters of a state. For example, the parameter “Wired Network” has empty parameter values for all states (rows). This may be interpreted as “the user device does not connect to a wired network in any state during the period T1 through T6”. The values of the parameter “GPS Location” may be interpreted as the “user device is in location L1 in state at time T1, has the value L2 in state at T2, etc.”.

To summarize, data records (rows) of the tabular data structure may be viewed as states of the computational behavior of a user device at a given time instant. The columnar values of the tabular data structure may be viewed as parameter values of the states. It is to be noted that the parameters shown in FIG. 1B are exemplary. In some embodiments, any number and kind of parameters may be chosen.

We have thus shown that environmental sensory datasets collected by a user device may be represented as tabular data structures.

Alternatively, we may represent environmental sensory datasets as finite state machines whose operations and utility are described in prior art. State machines describe states that are characterized by one or more parameter values and a transition function that imposes an ordering on the states. In the present invention, we will assume that the states are ordered temporally by the values of the Time Instant parameter of the environmental sensory dataset, i.e., the periodic rate of the recording operation of the monitoring logic. Thus, if the dataset was recorded at 6 time instants, say T1 through T6, the state machine will have 6 states, say S1 through S6, in the temporal sequence S1, followed by S2, . . . , followed by S6. Each state of the state machine is characterized by, i.e., contains, one or more parameter values recorded by the recording function of the monitoring service logic from the computational environment of the user device.

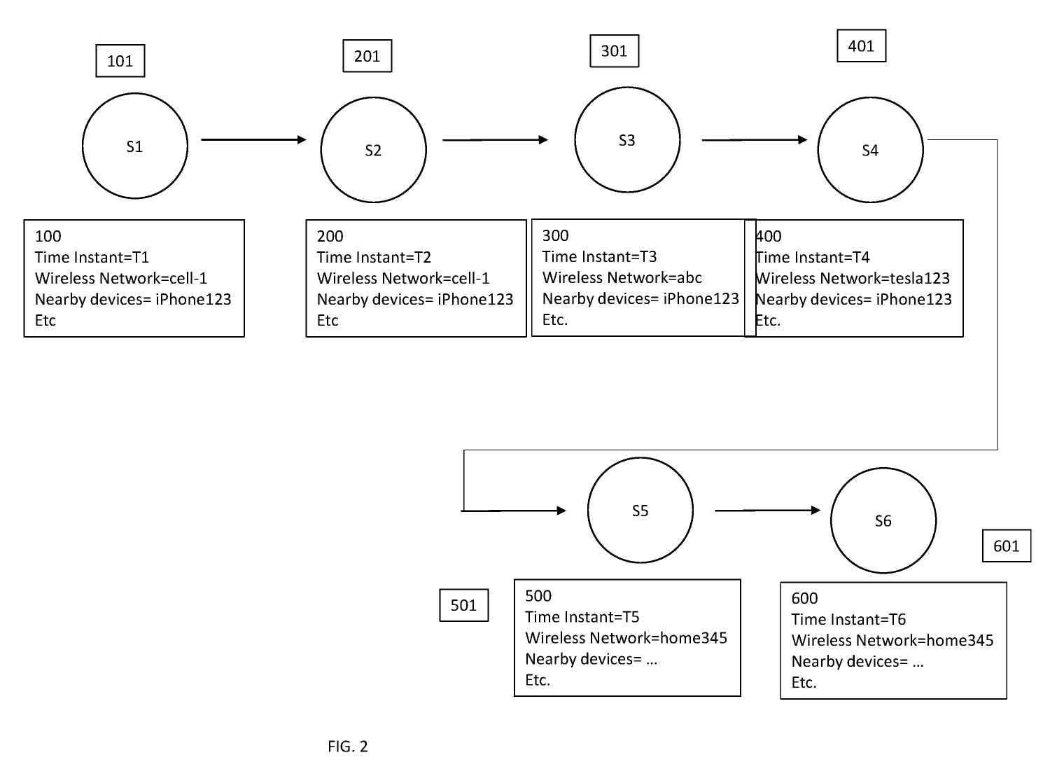

FIG. 2 shows an exemplary state machine for an environmental sensory dataset collected by the monitoring service logic. The states S1, S2, S3, S4, S5 and S6 correspond to the temporal sequence of the time instants T1 through T6 at which various environmental parameters are recorded. The values of these parameters characterize the states, e.g., state S1 is characterized by the list 100. Thus, e.g., in state 100, the user device is indicated to be nearby “iPhone123” and connected to wireless network Cell-1, etc.

### Profiles

We now describe methods by which device profiles may be derived from tabular or state machine representations of environmental sensory datasets.

A state of a user device is a set of parameter values for a given time instant. Integrating over all the states gives the configuration space of the user device. Thus, the environment in which a user device operates may be described as a configuration space of parameters over a set of time instants.

A profile of a user device is a projection of the configuration space over the “Time Instant” parameter and one or more additional parameters. That is, profiles comprise of values from two or more parameters.

Thus, projections of the configuration space of the user device represented by FIG. 1B yield sets of parameter values. For example, the projection over the parameters “Time Instant” and “GPS Location” of FIG. 1B yields the set of parameter values [(T1, L1), (T2, L1), (T3, L2), (T4, L3), (T5, L4), (T6, L4)] that may also be referred to as a profile of the user device. The projection over the parameters “Time Instant”, “Wireless Network” and “App Launched” yields the set of parameter values [(T1, cell-1, DB1), (T2, cell-1, DB1), (T3, abc, Spotify), (T4, tesla123, Spotify), (T5, home345, Video Calling), (T6, home345, Email)]. The latter set of parameter values may also be referred to as a profile of the user device.

To obtain device profiles from the tabular representations of environmental sensory datasets, we proceed as follows.

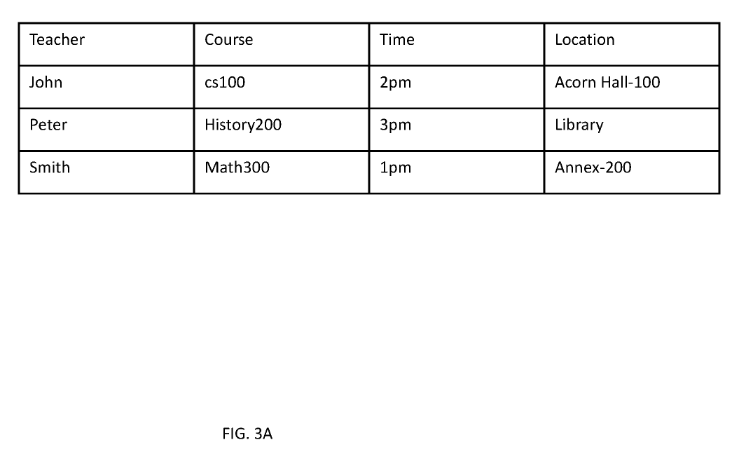

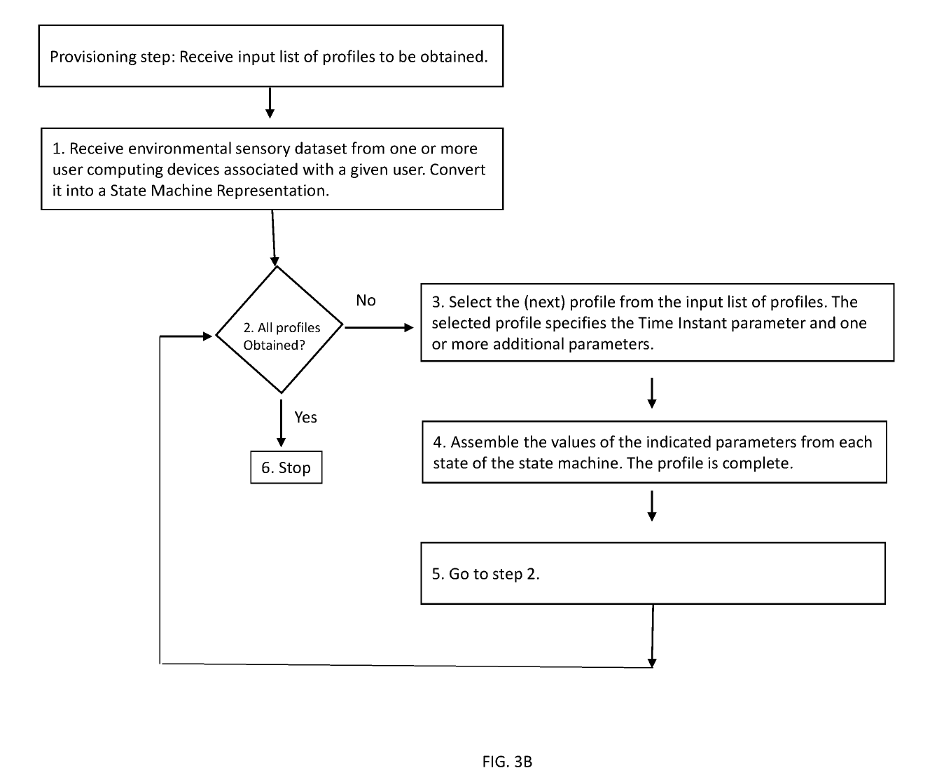

Prior art describes relational algebra operation of projection with respect to database tables. Consider the exemplary database table shown in FIG. 3A wherein the rows (data records) of the table show the courses taught by a professor and the times and locations of the class lectures.

The projection operator of relational algebra teaches methods by which the columnar values of a database table may be extracted. For example, the projection over “Course” of the table of FIG. 3B yields the set of values [cs100, History200, Math300]. Projecting over “Teacher” yields the set of values [John, Peter, Smith].

Thus, environmental sensory datasets when represented as tabular data structures may be treated as database tables and the projection operator of relational algebra may be applied to them.

For example, by applying the projection operator over the parameters Time Instant, Wireless Network and App Launched to the table of FIG. 1, we obtain the set of values [(T1, cell-1, DB1), (T2, cell-1, DB1), (T3, abc, Spotify), (T4, tesla123, Spotify), (T5, home345, Video Calling), (T6, home345, Email)]. Note that this set of values was shown above as an exemplary profile obtained from the configuration space of the user device, i.e., from the environmental sensory dataset.

Thus, to obtain profiles from an environmental dataset represented in a tabular form, we may proceed to apply the projection operator as above.

Alternatively, we may use the state machine representation of an environmental dataset to obtain profiles as follows.

Given a state machine representation of an environmental sensory dataset, we may imagine that we “play” states of the machine in temporal sequence much like playing the frames of a video. One may thus associate the parameter values in a temporal sequence of states with an informal narrative. For example, the parameter values (cell-1, cell-1, abc, tesla123, home345, home345) at time instants T1 through T6 may be associated with the informal narrative: the user device is connected to wireless network “cell-1” at time instants T1 and T2, the user device connects to a wireless network “abc” at instant T3, switches to wireless network “tesla123 at instant T4, and finally connects to wireless network “home345” at instants T5 and T6.

Similarly, the empty values of the parameter “Wired Network” for time instants T1 through T6 may yield the informal narrative “user device is not connected to a wired network”. Informal narratives thus correspond to an intuitive description of the computational behavior of the user device, i.e., the user.

We may obtain device profiles from the state machine of FIG. 2 by choosing the values of the “time instant” parameter and the values of one or more additional parameters, i.e., subset of values from each state of FIG. 2. One such profile, say P1, for the parameters Time Instant and Wireless Network may have the parameter values [(T1, cell-1), (T2, cell-1), (T3, abc), (T4, tesla123), (T5, home345), (T6, home345)] with respect to FIG. 1. We may refer to this as the wireless network profile.

Turning now to the parameter “Wired Network” in FIG. 1, we note that its values remain unchanged. Absence of a value is assumed to denote that the parameter has no value at the indicated time instant (equivalently, in the corresponding state). Any parameter whose values remain unchanged for all time instants or states may be interpreted as a constant.

FIG. 3B shows the method by which profiles may be obtained from the state machine representation of an environmental sensory dataset for a given user device by the supervisory program. Rather than obtaining all profiles from an environmental sensory dataset, we allow in a provisioning step, certain profiles to be specified. For example, we may specify the profile (Time Instant, Wireless Network) as one desired profile. Another exemplary desired profile may be (Time Instant, Nearby Device, App Launched).

As described above, an exemplary profile, i.e., is a list of elements. Note that the parameter Time Instant is included in every element of the list corresponding to a profile.

In a provisioning step, the desired profiles are specified by system administrators to the supervisory program by listing the parameters of the profiles, e.g., the profile corresponding to the parameters (Time Instant, Wireless Network).

In step 1, the supervisory program of the database system receives environmental sensory datasets from the monitoring service logics provisioned to the one or more computing devices associated with the user of the database system. The supervisory program converts the received dataset into a state machine representation.

At the conclusion of step 1, the supervisory program has the state machine representation of the environmental dataset and the list of profiles to be obtained from it. An example of the latter is the list P1 and P2 where profile P1=(Time Instant, Wireless Network) and P2=(Time Instant, Wireless Network, Nearby Device).

In step 2, the method tests if all the desired profiles have been obtained. If so, the method terminates. Otherwise, the method proceeds to perform steps 3-6.

In step 3, we select the (next) profile to be obtained from the input list of profiles. The selected profile specifies the parameters, e.g., profile P1 specifies the parameters Time Instant and Wireless Network.

In step 4, for each specified parameter, assemble the values of the specified parameters from each state of the state machine.

After step 4, a profile has been obtained and we are now ready for obtaining the next profile specified in the input list of desired profiles. In step 5, we return to testing if all desired profiles have been obtained.

The method terminates in step 6 when all desired profiles have been obtained.

An exemplary profile obtained as described above may apply to a user named, say John. Consider, by way of example, a profile of the wireless network connections of John's user device. At time T1, John is at location “L1” and at time T2 he is at location “L2”. At both locations, he is connected to network “cell-1”. At time T3 John connects to network “abc” that may be known to be a coffee shop. (Many internet service providers have collected and maintain databases that associate locations and appliances, e.g., automobiles, with Wi-Fi/Bluetooth networks.) John then connects to network “Tesla123” known to be a Wi-Fi network associated with a smart car manufacturer at time T4. At times T5 and T6 John is connected to network “home345” at location L4 that may be known as John's home address.

Thus, a “Wireless Network” profile of John's user device may describe a possible sequence of events, e.g., John goes from location L1 to L2, enters a coffee shop, later gets into his car and arrives home, the sequence of activities occurring over the period T1 through T6. That is, the profile may capture a computational behavior of the user John.

Similarly, a “Nearby Device” profile of John's user device may show that John connects to network “home123” for a duration of time “(T5-T4)” with nearby device iPhone123. A possible sequence of events that one may obtain from John's nearby devices and locations is that he spends time T5-T4 with someone in his house.

We discuss the columns “#processes” and “process with max time” of FIG. 1B in more detail later.

We thus see that several profiles may be obtained from an exemplary tabular data structure such as shown in FIG. 1B (equivalently, the state machine of FIG. 2) and that these profiles may encapsulate activities and actions of users. Therefore, the possibility arises that we may compare a given profile with previously saved profiles to find statistically similar or outlying user behaviors.

Device profiles thus represent a user's “historical” computational behavior that may then be compared with his “current” behavior to allow or disallow the user's authentication (and other) requests.

### Matching User Profiles

We now present the method by which a training profile and an operational profile, say P1 and P2 respectively, may be matched. We require that the profiles to be matched pertain to the same (projection) parameters. Since profiles are sets (of parameter values), they may be matched by placing the two sets in (one-to-one) correspondence. Thus, if set1 is [element11, element12, element13, . . . ] and set2 is [element21, element22, element23, . . . ] then set1 and set2 may be placed in (one-to-one) correspondence as follows:

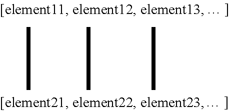

The two sets may thus be matched by checking for equality of the elements placed in correspondence. Note that elements of profiles will generally contain two or more components, e.g., pairs, or triples, etc., in which case we place all components in (one-to-one) correspondence.

Matching based on equality of correspondence is simple, but it may be too restrictive in practice. The basic idea behind profile matching is that training profiles indicate a general behavior of the user whereas his operational profile is indicative of his immediate behavior. If training and operational profiles match, we may be assured that the immediate behavior of the user is similar to his general behavior.

In practice, however, user behaviors may typically vary from day to day, but not by much. To accommodate such variance, we may wish to broaden the notion of profile matching by generalizing the notion of equality in correspondence-based matching. That is, when checking for equality of elements placed in correspondence, we may wish to, for example, determine the amount of computational effort that may be needed to achieve equality for two given profiles.

Consider, by way of example, the profiles P3 and P4 placed in (one-to-one) correspondence:

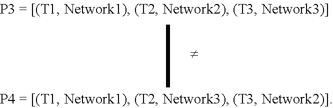

Equality-based correspondence of P3 and P4 fails since the element (T2, Network2) of P3 is not equal to element (T2, Network3) of P4.

The correspondence between P3 and P4 may be made to succeed, however, if we “change” P4 to
P4′=[(T1, Network1), (T2, Network2), (T3, Network3)].

That is, the change involves exchanging the second component of the second element of P4′ with the second component of the third element of P4′. We refer to the exchange operation as a flip and note that in this example we needed 1 flip operation to achieve a successful matching of P3 and P4.

We propose the idea of using the number of flip operations needed to achieve equality in correspondence between two profiles as a measure of the amount of computational effort. Thus, if two profiles require 4 flip operations to match using equality in correspondence, we may say that the amount of computational effort is 4.

Note that the flip operation may be applied to either the training or the operational profiles that are being matched. In some embodiments, the flip operations may be further restricted to apply to either the training profile or the operational profile, but not both.

Clearly, matching two profiles using equality in correspondence is a special case that requires zero flip operations. That is, when the number of flips is zero, we have the case of equality in correspondence. For number of flips>0, we have the more general notion of modifying the profiles before matching. Thus, the number of flips provides a measure of the computational effort needed in matching profiles.

Correspondence-based matching is one strategy for matching two profiles. Another possible strategy, e.g., may involve using statistical measures such as “total” or “average”. Consider, by way of example, the training profile P1 over the parameters Time Instant and Wireless Network:
[(T1, Network1), (T2, Network2), (T3, Network3), (T4, Network2), (T5, Network1)]

We may calculate from the values of T1 through T5 the total amount of time that the user device was connected to one or more wireless networks. We may also calculate the average amount of time the user device was connected to a particular network, say Network2.

Now given an operational profile, say P5, we may match P5 with a training profile P6 as follows. Let the total time connected to wireless networks as indicated by profile P5 be N1 and by profile P6 be N2. Then, if the condition “absolute(N1−N2)≦10 units” is true when matching P5 and P6 may indicate a successful match and failure otherwise.

Similar strategies may be devised that use other statistical measures.

Whereas we have only shown a few matching strategies, many such strategies may be designed by system administrators.

In summary, a general method for utilizing user profiles to authenticate a user may involve a two-step process. In the first step, called the “training phase”, the supervisory program obtains a group of profiles, called “training profiles”, from the tabular or state machine representations of the environmental dataset of the user device. During this phase, the user may be allowed temporary and/or restricted access to the system. Alternatively, a secondary authentication mechanism, e.g., username/password, may be employed.

In the second phase of the process, called the “operational phase”, the user's computing device provides an environmental sensory dataset that is assembled into a tabular data structure, e.g., FIG. 1B, or as a state machine (cf. FIG. 2), from which a group of operational profiles are derived.

An authentication and/or an authorization mechanism may then be defined by selecting one or more suitable matching strategies in which the training profiles are matched against the corresponding operational profiles. The matching strategies that are employed may in part depend on whether authentication, authorization or both authentication and authorization are to be performed

### Lost Device

We now assume that a user loses his computing device. Two problems need to be addressed.
Can a malicious user find and use the lost device to gain access?
How does the user acquire and register a new device?

To answer the former concern, note that to gain access, the lost device needs to generate an environmental sensory dataset and provide it to the supervisory program. Furthermore, the provided dataset, in combination with datasets provided by one or more computing devices associated with the user, must yield one or more profiles that satisfy the selected matching processes.

Such a possibility could only happen if the computational behavior of the malicious user mimics the behavior of the original user. Since the computational behavior of the latter comprises actions in the physical world with its innumerable degrees of freedom, it is extremely unlikely that the malicious user can mimic the computational behavior of the original user.

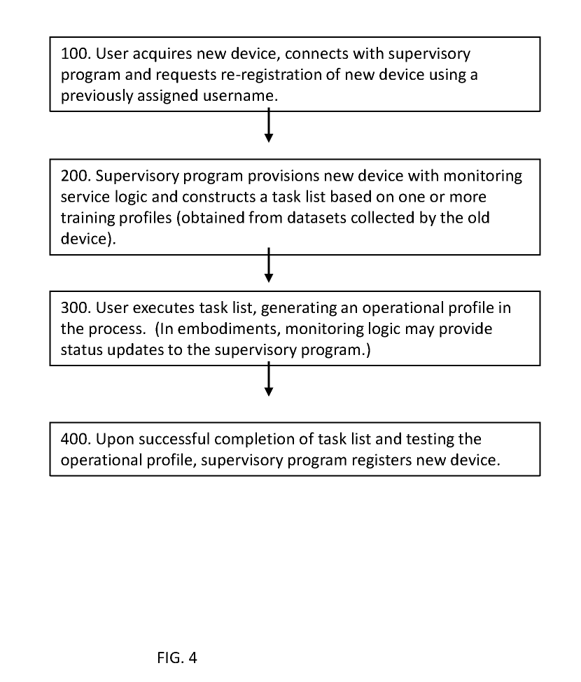

The latter concern poses a problem because to register a device, a user needs to undergo the training phase that may introduce an unacceptable delay. We also need to ensure that the request for registering a new device is made by the same user who owned the previous “lost” device. We propose the following process depicted in FIG. 4.

In step 100, the user acquires a new device to replace the lost device, identifies himself to the supervisory program using, e.g., a previously assigned username.

In step 200, the supervisory program provisions the new user device with a special version of the monitoring service logic that allows the generation of operational profiles on a temporary basis. The supervisory program selects one or more of the training profiles associated with the old “lost” user device and constructs a “task list” described below. The task list is communicated to the new user device.

In step 3, the user executes the task list and the supervisory program determines that the execution was “satisfactory” based on various tests (described below) pertaining to the operational profile generated by the user device whilst executing the task list.

In step 400, the supervisory program upon satisfactory execution of the task list and tests registers the user's new device.

The idea underlying the method of FIG. 4 may be explained as follows.

When the user identifies himself with a previously assigned username, the supervisory program may access one or more training profiles associated with the assigned username. Each profile represents a computational behavior, e.g., a profile may state that the user connected using a wireless network from location L1 during time period T3-T2, etc.

Thus, a profile may be viewed as describing a set of actions undertaken by the user.

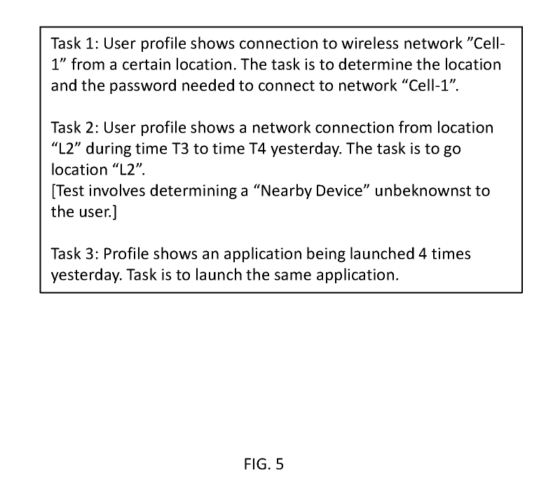

The supervisory program may thus select one or more training profiles and construct a list of actions, i.e., a task list, that the user may be asked to perform. An exemplary task list is shown in FIG. 5.

In exemplary task 1 of FIG. 5, the user is asked to determine a place where he was yesterday at a given time. The supervisory program may not reveal the location to the user, thereby requiring the user to perform the task from previously known behaviors. Whilst executing the task list, the (special) monitoring logic in the user device generates an operational profile that may tested by the supervisory program. To check if the user has satisfactorily fulfilled task 1, the supervisory program may check the operational profile to ascertain the indicated GPS location of the user device.

Further, the user may be asked to connect to a named wireless network available at the required location, but the password needed for making the connection is not revealed to the user. That is, the supervisory program may expect the user to know the password of the network from past behavior as indicated by his training profiles.

In exemplary task 2, the supervisory program asks the user to perform a task that seemingly does not require any past knowledge of the user's behavior. For example, the user may be asked to go to a specified location and perform an action that triggers the supervisory program. For example, the user may be asked to visit a specified website and click an item displayed on the website. (The item may be programmed to deliver a trigger to the supervisory program when clicked. Various methods to achieve such triggering are known in prior art, e.g., hyperlinks.)

Upon receipt of the trigger, the supervisory program may use the GPS sensor of the user device to ascertain the location of the user device. Furthermore, and more importantly, the supervisory program may check the computational environment of the device (via the operational profile) for other parameter values known to the supervisory program from the training profile of the “lost” device, but not known to the current user. For example, the supervisory program may check the operational profile for Nearby Devices that may have “paired” with the old, i.e., lost, device. Since the parameter Nearby Devices is not displayed in the task list shown to the user, the latter may not be aware of the checking performed by the supervisory program. Thus, the operational profile may not indicate values of the Nearby Devices parameter or show values that differ from those shown by the training profiles. Furthermore, if the current user is different from the owner of the lost computing device, the former may not know the pin code or password used in the pairing operation with the Nearby Device indicated by the training profile.

For example, consider a user whose training profile indicates that when he is connected to a certain wireless network, a particular nearby device is always present. The user may have a dog wearing a smart collar that pairs with the owner's computing device using a discovery and/or proximity protocol. In such a case, the user may be set the task to connect to his home network. Unbeknownst to the user, the supervisory program may check for the value of the Nearby Device parameter in the operational profile. Thus, the identity of the user may be established by the successful pairing of his new computing device with the dog's collar.

In exemplary task 3, the user may be asked to perform tasks requiring prior knowledge of the user, e.g., determine an application used on multiple occasions on a given day.

In this manner, a satisfactory execution of a task list derived from one or more training profiles ascertains the identity of the user since the execution of the tasks require the new user computing device to mimic the computational behavior of the original device.

In some embodiments, the above process for associating a new user device with a previously known user (and his profiles) may be implemented as an online game wherein the user of the new computing device is assigned a task list. As the user “plays” the game, i.e., executes the task list, the user may be assigned points in the sense that each satisfactory execution of a task may result in a given number of points. As the user plays the game, based on the knowledge of his computational history, he collects points or accumulates treasure and a certain, e.g., cumulative score, may be used to indicate success.

Problems with Irregular Behavior Patterns

The methods of the present invention may not authenticate a user who radically and suddenly changes his normal computational behavior or routine. By way of example, consider a user who is quite regular in his daily routine. His environmental sensory dataset is developed as explained above. If one day the user alters his routine, e.g., goes on vacation to an exotic locale, his training and operational profiles may not match.

Unlike the “lost device” case above in which the user was asked to know his past computational actions to determine his authenticity, in this case the user is currently authenticated, but may not be in the future. We note, however, that the user may “know” his “future” computational actions, i.e., his plans.

We propose the following method to solve the problem. A user informs the supervisory program of his plans, e.g., intention to travel to a specific new location for one week. The supervisory program assigns certain tasks for the user to perform when the user reaches the new location. (In some embodiments, in transit actions may also be proposed.)

For example, the user may be asked to remember a short message and send it as a text message to a specified address upon reaching the new location. A user may be asked to connect with a known Wi-Fi network at the new location, e.g., the Wi-Fi network of a known hotel. The user may be asked to visit a specified website upon reaching the specified location and click a specified item on the website. As described earlier, receipt of the text message or the clicking action of the user may trigger the supervisory program.

Once triggered, the supervisory program may now not only ascertain that the user is at the specified location (via GPS coordinates obtained from the user device), but also it may trigger the monitoring logic in the user device to collect a new training dataset. The latter may then be utilized by the supervisory program to obtain one or more new training profiles.

That is, as the user performs the indicated computing actions upon arrival at the new location, the supervisory program receives the environmental sensory datasets from the user's computing devices, and constructs a set of training profiles that may then be used to authenticate the user for the duration of the user's sojourn.

Problems with Trojan Horses

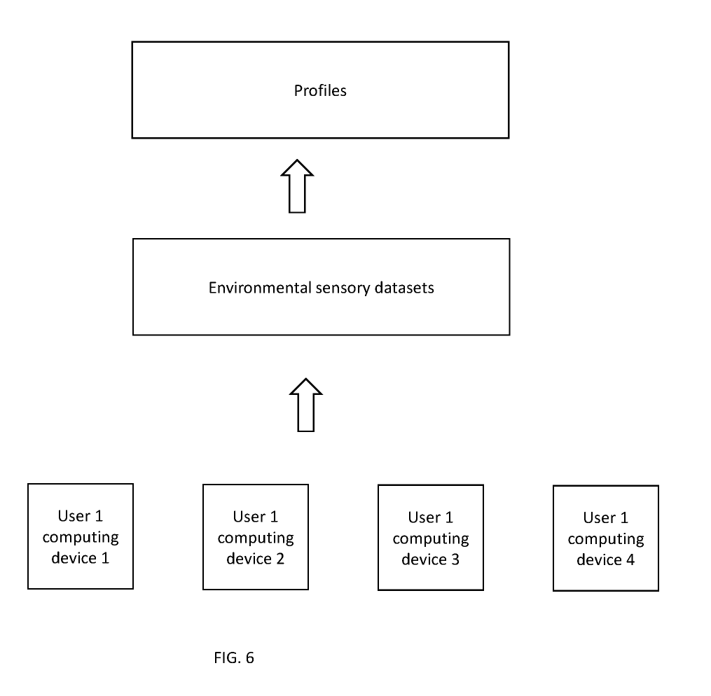

FIG. 6 shows four user computing devices assigned to a single user that provide environmental sensory datasets to the supervisory program that then constructs a tabular data structure and derives one or more user profiles for the given user as described by the methods of FIG. 3A. This process may be used for every user of the system. Thus, we may modify the “time instant” column of FIG. 1B to identify both the user device (UD) and the time instant (TI), i.e., replace, e.g., T1 with (UD-1, T1) signifying that the row corresponds to parameters obtained from device UD-1 at time instant T1, etc.

Alternatively, we may construct a state machine representation of the dataset in which the values of the parameters in each state contains the additional values for the user device parameter. We may then use the method of FIG. 3B to obtain profiles for all devices of a user.

The descriptions provided above have concentrated on a single user, possibly with multiple computing devices. However, we may also collect environmental sensory datasets from all devices of all users and obtain profiles as above. Whereas profiles obtained from a single user's environmental sensory dataset represent his computational behavior (as described above), profiles obtained from the environmental sensory datasets of all users represent overall or general computational behavior of the population of users. We may use such general profiles as follows.

Malicious agents have been known to inject computer programs into systems that proceed to simulate authenticated users of the system, extract data and engage in unauthorized activities. Such programs have sometimes been referred to as “Trojan Horses”. Thus, Trojan horses “hide” as authenticated programs and gain unauthorized access to resources.

The inventions described herein may be used to detect Trojan horses as follows. Recall that we associate training profiles with a user derived from his computational behavior, which in turn is a representation of the user's actions. As a Trojan Horse program runs, it may create processes that perform, e.g., read and/or write data operations, or perform other computations, etc.

FIG. 1B shows exemplary columns “#processes#”, “DHCP parameters” and “process with max time”. One purpose of these columns is to capture process information at the operating system level. In a certain sense, such process information may be viewed as providing a signature of a computer program as it executes, i.e., it is a representation of the behavior of a computer program.

In other words, we may treat various operating system parameters as being indicative of the operating environment in which computer programs execute. Capturing one or more such parameters in a dataset and deriving a profile from such a dataset provides a way to encapsulate the computational behavior of computer programs. Thus, we may obtain database operating environment data as a dataset from the user devices of authenticated users accessing and processing the data in a database. Such datasets may then be processed to derive training profiles using the methods described above. These training profiles will then represent customary and usual behaviors of authenticated users. Departures from such behaviors may indicate unusual activities.

By matching such training profiles of database users with operational profiles of current users, we may detect unusual activity meriting further analysis. That is, a Trojan Horse program will behave abnormally compared to the general behavior of other users. For example, a Trojan Horse may copy large portions of the database, i.e., an operation that may demand scrutiny since it may be quite unusual as per the training profiles of other users. A malicious program may engage in unusual input/output operations, etc., that may be detected by matching operational and training profiles.

Those skilled in the art will observe that the authentication/authorization methods described herein are immune to attacks based on guessing or generating keys, usernames, passwords, etc., since the methods of the present invention do not rely on combinations of a known alphabet of symbols. Particularly, a computer, e.g., quantum computer, based on explicating all possible future histories of an input function, e.g., a wave function encapsulating a finite alphabet, may not be used to overcome the present invention's authentication/authorization mechanism since the required input function for such a computer would entail encapsulating the practically innumerable parameters of a user's physical world.

The present invention also anticipates the advent of quantum computers into everyday use by the public, i.e., personal quantum computers. In such an eventuality, owners of personal quantum computers will need an authentication mechanism to protect their own computers (much like the username/password based schemes used today). Since today's username/password based schemes will become unsafe with personal quantum computers, the present invention may be used to design authentication/authorization schemes for personal quantum computers.

In some embodiments, a user computing device may be provisioned with monitoring service logic that generates a first dataset that, in turn, may be used to obtain one or more training profiles by a cloud-based authentication service. The user computing device may then, upon demand, produce a second dataset that may be provided to the cloud service that may obtain an operational profile from it. The cloud service may then, upon matching the training profiles with the operational profile, communicate an action to the personal quantum computer, the action indicating allowance or disallowance of access by the user to the personal quantum computer.

The present invention thus introduces technology that applies to computers that are anticipated to be available in the years ahead.

Those skilled in the art will also observe that the monitoring service logic in the user's computing devices may itself be protected by storing it in encrypted form. Thus, a user may not be able to discern the contents of the stored monitoring logic or the datasets that it collects.

Furthermore, the monitoring service logic may be provided or made available to the user computing devices in various forms, e.g., as an app, executable code, or pre-packaged into the operating system of the user computing device, etc.

As has been described above, the monitoring logic creates a first and a second dataset that it may provide to the supervisory program. The latter may need to ensure that the first and second datasets are indeed provided by the same monitoring logic. That is, the monitoring logic may need to authenticate itself to the supervisory program. Such an authentication may be achieved using conventional techniques, e.g., a certificate mechanism or an API (application program interface) certificate mechanism.

### Illustrative Architecture

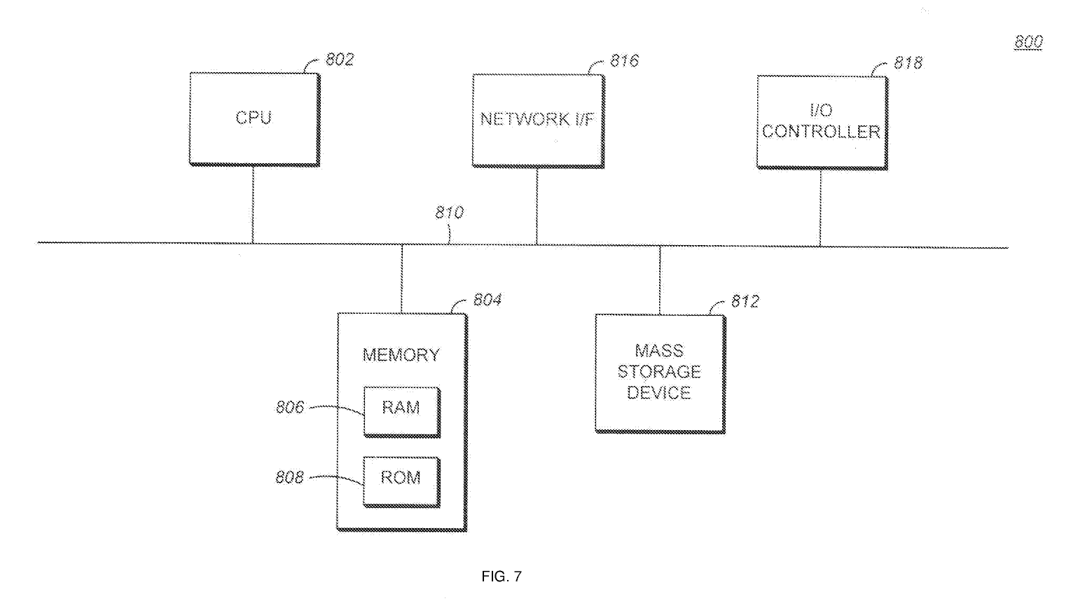

FIG. 7 shows an example architecture 800 for a device such as the user computing device or the access control mechanism that executes the supervisory program that provides a user access to a database or other online resource. Thus, the architecture 800 illustrated in FIG. 7 shows an architecture that may be adapted for a server computer, server complex, mobile phone, a PDA, a smartphone, a desktop computer, a netbook computer, a tablet computer, GPS device, gaming console, and/or a laptop computer. The architecture 800 may be utilized to execute any aspect of the components presented herein.

The architecture 800 illustrated in FIG. 7 includes a CPU (Central Processing Unit) 802, a system memory 804, including a RAM 806 and a ROM 808, and a system bus 810 that couples the memory 804 to the CPU 802. A basic input/output system containing the basic routines that help to transfer information between elements within the architecture 800, such as during startup, is stored in the ROM 808. The architecture 800 further includes a mass storage device 812 for storing software code or other computer-executed code that is utilized to implement applications, the file system, and the operating system.

The mass storage device 812 is connected to the CPU 802 through a mass storage controller (not shown) connected to the bus 810. The mass storage device 812 and its associated non-transitory computer-readable storage media provide non-volatile storage for the architecture 800.

Although the description of non-transitory computer-readable storage media contained herein refers to a mass storage device, such as a hard disk or CD-ROM drive, it should be appreciated by those skilled in the art that non-transitory computer-readable storage media can be any available storage media that can be accessed by the architecture 800.

By way of example, and not limitation, non-transitory computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 800.

According to various embodiments, the architecture 800 may operate in a networked environment using logical connections to remote computers through a network. The architecture 800 may connect to the network through a network interface unit 816 connected to the bus 810. It should be appreciated that the network interface unit 816 also may be utilized to connect to other types of networks and remote computer systems. The architecture 800 also may include an input/output controller 818 for receiving and processing input from a number of other devices, including a keyboard, mouse, or electronic stylus (not shown in FIG. 7). Similarly, the input/output controller 818 may provide output to a display screen, a printer, or other type of output device (also not shown in FIG. 7).

It should be appreciated that the software components described herein may, when loaded into the CPU 802 and executed, transform the CPU 802 and the overall architecture 800 from a general-purpose computing system into a special-purpose computing system customized to facilitate the functionality presented herein. The CPU 802 may be constructed from any number of transistors or other discrete circuit elements, which may individually or collectively assume any number of states. More specifically, the CPU 802 may operate as a finite-state machine, in response to executable instructions contained within the software modules disclosed herein. These computer-executable instructions may transform the CPU 802 by specifying how the CPU 802 transitions between states, thereby transforming the transistors or other discrete hardware elements constituting the CPU 802.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

In some embodiments, the software modules or components may include software for implementing the monitoring service logic (in the case of the user computing device) or the supervisory program (in the case of the access control mechanism). More generally, the monitoring service logic and the supervisory program may be implemented in any combination of hardware, software and firmware.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 800 in order to store and execute the software components presented herein. It is also contemplated that the architecture 800 may not include all of the components shown in FIG. 7, may include other components that are not explicitly shown in FIG. 7, or may utilize an architecture completely different from that shown in FIG. 7.

The above description of illustrated examples of the present invention is not intended to be exhaustive or limited to the precise forms disclosed. While specific embodiments of, and examples for, the invention are described herein for illustrative purposes, various equivalent modifications are possible without departing from the broader spirit and scope of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

1. A method of authorizing a user to access a resource over a communication network, comprising:
receiving over a communication network from a computing device associated with the user a temporal sequence of operational data of parameter values for one or more parameters monitored by the computing device;
comparing the temporal sequence of operational data to a temporal sequence of previously received training data of parameter values previously monitored by the communication device for the one or more parameters; and
allowing the computing device access to the resource if the temporal sequence of previously received training data matches the temporal sequence of operational data to within a specified confidence level.

2. The method of claim 1, wherein the temporal sequence of operational data and the temporal sequence of previously received training data includes environmental data obtained from one or more sensors incorporated in or associated with the computing device.

3. The method of claim 1, wherein the temporal sequence of operational data and the temporal sequence of previously received training data includes data indicative of network connectivity of the computing device with one or more networks.

4. The method of claim 1, wherein the temporal sequence of operational data and the temporal sequence of previously received training data includes data indicative of network connectivity of the computing device with one or more networks.

5. The method of claim 1, wherein the temporal sequence of operational data and the temporal sequence of previously received training data includes parameter values for parameters reflective of one or more operational states of the computing device.

6. The method of claim 5, wherein the operational states are selected from the group comprising a number of processes being executed on the computing device, a number of applications launched on the computing device, a process being executed on the computing device that requires more time to execute than any other process being executed on the computing device and a Dynamic Host Configuration Protocol (DHCP) protocol being used by the computing device.

7. The method of claim 1, further comprising receiving the temporal sequence of operational data and the temporal sequence of previously received training data for the one or more parameters over a communication network by an access control mechanism that controls access to the resource, the comparing being performed by the access control mechanism.

8. The method of claim 1, wherein the parameter values being compared are parameter values for a subset of the parameters whose parameter values are collected.

9. The method of claim 1, further comprising determining if the temporal sequence of previously obtained training data matches the temporal sequence of operational data to within a specified confidence level based on a measure of computational effort needed to make the parameter values in the temporal sequence of training data be equal to corresponding parameter values in the temporal sequence of the operational data.

10. The method of claim 9, wherein the measure of computational effort is determined at least in part by a number of flip operations needed to make the parameter values in the temporal sequence of training data be equal to corresponding parameter values in the temporal sequence of operational data.

11. The method of claim 1, further comprising determining if the temporal sequence of previously received training data matches the temporal sequence of operational data to within a specified confidence level based at least in part on a comparison of one or more statistical measures of the parameter values in the previously received training data with the parameter values in the operational data.

12. A method of gaining access to a resource over a communication network, comprising:
(i) obtaining, with a computing device associated with a user, a temporal sequence of training parameter values for one or more parameters being monitored by the computing device;
(ii) sending the training parameter values over a communication network from the computing device to an access control mechanism associated with the resource;
(iii) subsequent to (i), obtaining, with the computing device, a temporal sequence of operating parameter values for the one or more parameters being monitored by the computing device;
(iv) sending the operating parameter values over the communication network from the computing device to the access control mechanism; and
(vi) receiving from the access control mechanism over the communication network access to the resource if the temporal sequence of training parameters values matches the temporal sequence of operational parameter values to within a specified confidence level.

13. The method of claim 12, wherein the monitoring of the one or more parameters is performed by monitoring service logic incorporated in the computing device.

14. A non-transitory computer readable medium, comprising instructions for causing a computing environment to perform a method comprising:
(i) collecting information from a computing environment of a user over a first period time to define a first dataset;
(ii) subsequent to (i), collecting information from the computing environment of the user over of a second period of time to define a second dataset;
(iii) obtaining one or more first device profiles from the first dataset and obtaining one or more second device profiles from the second dataset;
(iv) upon receiving an authentication and/or an authorization request from the user, matching at least one of the first device profiles with at least one of the second device profiles; and
(vi) responding positively to the authentication and/or authorization request if the matching is successful and responding negatively if the matching is not successful.
